(19) United States
(12) Patent Application Publication
(10) Pub. No.: US 2026/0045603 A1
(43) Pub. Date: Feb. 12, 2026

(54) SHEET FOR OUTER PACKAGE AND POWER STORAGE DEVICE COMPRISING SAME

(71) Applicant: NITTO DENKO CORPORATION, Osaka (JP)

(72) Inventors: Yusuke NAKAYAMA, Osaka (JP); Kou UEMURA, Osaka (JP); Shunji IMAMURA, Osaka (JP)

(73) Assignee: NITTO DENKO CORPORATION, Osaka (JP)

(21) Appl. No.: 18/997,906

(22) PCT Filed: Jul. 26, 2023
(86) PCT No.: PCT/JP2023/027460

§ 371 Date: Sep. 25, 2025

(30) Foreign Application Priority Data
Jul. 29, 2022 (JP) 2022-122188

(51) Int. Cl. H01M 50/121; B32B 27/08; B32B 27/32; H01M 10/0525; H01M 50/124

(52) U.S. Cl. CPC H01M 50/121; B32B 27/08; B32B 27/32; H01M 50/124; B32B 2250/02; B32B 2250/242; B32B 2457/10; H01M 10/0525

(57) ABSTRACT

Provided is a sheet for an outer package configured to store a power storage element in a power storage device, the sheet for an outer package including a non-porous resin sheet, wherein the sheet for an outer package has a peel force F of 1.5 N/10 mm or more, which is determined by the following evaluation method. The sheet for an outer package is suitable for the suppression of the swelling of a power storage device.

—Evaluation Method— A rectangular test piece measuring 10 mm wide by 100 mm or more long, which is obtained by joining the sheet for an outer package serving as an evaluation object and a polypropylene sheet to each other through hot pressing, is subjected to a tear-off test in which the sheet for an outer package is torn off the polypropylene sheet at a peel rate of 300 mm/min in a 180° direction, and a 180° tear-off peel force thus measured is defined as the peel force F.

### TECHNICAL FIELD

The present invention relates to a sheet for an outer package and a power storage device including the sheet.

### BACKGROUND ART

A power storage device, such as a battery or a capacitor, typically includes a power storage element, such as an electrode group or an electrolyte, and an outer package that stores the power storage element. In Patent Literature 1, there is a disclosure of a pouch-type lithium secondary battery including a pouch-shaped outer package formed of a multilayer sheet obtained by laminating polypropylene sheets on both the surfaces of a metal sheet. The polypropylene sheets are often used in the outer packages of power storage devices because of low chemical reactivity and low gas permeability exhibited by polypropylene. The metal sheet functions as a gas barrier layer.

### CITATION LIST

### Patent Literature

Patent Literature 1: JP 2011-508956 A

### SUMMARY OF INVENTION

### Technical Problem

In a power storage device including a pouch-shaped outer package, the swelling of the device due to an increase in internal pressure is liable to be a problem as compared to a cylindrical or rectangular power storage device including a relatively hard outer package. The above-mentioned problem is remarkable particularly in a lithium-ion battery in which a gas is liable to be produced by an overcharge or an overdischarge. In Patent Literature 1, an attempt has been made to solve the above-mentioned problem through the improvement of an electrolyte. However, the suppression of the swelling of the power storage device is still insufficient.

An object of the present invention is to provide a sheet for an outer package suitable for the suppression of the swelling of a power storage device.

### Solution to Problem

To suppress the swelling of a power storage device, the inventors of the present invention have paid attention to the use of a resin sheet different from a multilayer sheet including a polypropylene sheet and a metal sheet in an outer package, and have advanced an investigation on the basis of this idea. Thus, the inventors have completed the present invention.

According to one aspect of the present invention, there is provided a sheet for an outer package configured to store a power storage element in a power storage device, the sheet for an outer package including a non-porous resin sheet, wherein the sheet for an outer package has a peel force F of 1.5 N/10 mm or more, which is determined by the following evaluation method:

### —Evaluation Method—

a rectangular test piece measuring 10 mm wide by 100 mm or more long, which is obtained by joining the sheet for an outer package serving as an evaluation object and a polypropylene sheet to each other through hot pressing, is subjected to a tear-off test in which the sheet for an outer package is torn off the polypropylene sheet at a peel rate of 300 mm/min in a 180° direction, and a 180° tear-off peel force thus measured is defined as the peel force F.

According to another aspect of the present invention, there is provided a power storage device, including: a power storage element; and an outer package configured to store the power storage element, wherein the outer package includes the sheet for an outer package according to the one aspect of the present invention.

### Advantageous Effects of Invention

A multilayer sheet including a polypropylene sheet and a metal sheet is excellent in gas barrier property, and hence has high performance by which water vapor or oxygen in an environment is prevented from permeating into a power storage device. However, the multilayer sheet is poor in performance by which a gas produced in the power storage device is discharged. The sheet for an outer package of the present invention has a peel force F with respect to the polypropylene sheet of 1.5 N/10 mm or more, and is hence suitable for use in an outer package in combination with the polypropylene sheet widely used in the power storage device. The use of the sheet for an outer package of the present invention in at least part of an outer package can improve gas-discharging performance as compared to an outer package formed of the above-mentioned multilayer sheet. In addition, the resin sheet included in the sheet for an outer package of the present invention is non-porous, and is hence advantageous as compared to a porous sheet in terms of the suppression of the permeation of water vapor or oxygen into the power storage device.

### BRIEF DESCRIPTION OF DRAWINGS

FIG. 1 is a sectional view for schematically illustrating an example of a sheet for an outer package of the present invention.

FIG. 2 is a sectional view for schematically illustrating an example of the sheet for an outer package of the present invention.

FIG. 3 is a sectional view for schematically illustrating an example of an aspect in which the sheet for an outer package of the present invention is used.

FIG. 4 is a sectional view for schematically illustrating an example of the aspect in which the sheet for an outer package of the present invention is used.

FIG. 5 is a schematic view for illustrating a method of evaluating the peel force F of a sheet for an outer package with respect to polypropylene.

### DESCRIPTION OF EMBODIMENTS

A sheet for an outer package according to a first aspect of the present invention is a sheet for an outer package configured to store a power storage element in a power storage device, the sheet for an outer package including a non-porous resin sheet, wherein the sheet for an outer package has a peel force F of 1.5 N/10 mm or more, which is determined by the following evaluation method:

### —Evaluation Method—

a rectangular test piece measuring 10 mm wide by 100 mm or more long, which is obtained by joining the sheet for an outer package serving as an evaluation object and a polypropylene sheet to each other through hot pressing, is subjected to a tear-off test in which the sheet for an outer package is torn off the polypropylene sheet at a peel rate of 300 mm/min in a 180° direction, and a 180° tear-off peel force thus measured is defined as the peel force F.

In a second aspect of the present invention, for example, in the sheet for an outer package according to the first aspect, the resin sheet contains a fluororesin.

In a third aspect of the present invention, for example, in the sheet for an outer package according to the second aspect, the fluororesin is polytetrafluoroethylene.

In a fourth aspect of the present invention, for example, the sheet for an outer package according to any one of the first to third aspects has a main surface having a surface roughness of 30 nm or more in terms of arithmetic average roughness Ra specified in the Japanese Industrial Standards (hereinafter referred to as “JIS”) B0601:2001.

In a fifth aspect of the present invention, for example, in the sheet for an outer package according to any one of the first to fourth aspects, the power storage device is a lithium-ion battery.

In a sixth aspect of the present invention, for example, in the sheet for an outer package according to the fifth aspect, the lithium-ion battery is a pouch type.

A power storage device according to a seventh aspect of the present invention is a power storage device, including: a power storage element; and an outer package configured to store the power storage element, wherein the outer package includes the sheet for an outer package according to any one of the first to sixth aspects.

In an eighth aspect of the present invention, for example, in the power storage device according to the seventh aspect, the outer package further includes: a multilayer sheet including a polypropylene layer or a polypropylene sheet; and a joining portion of the sheet for an outer package and the polypropylene layer or the polypropylene sheet.

Embodiments of the present invention are described below with reference to the drawings.

### [Sheet for Outer Package]

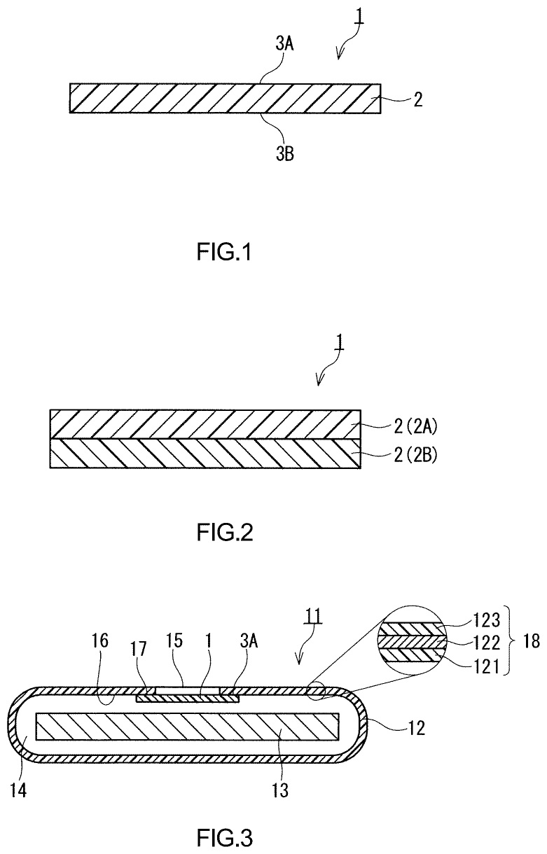

An example of the sheet for an outer package of the present invention is illustrated in FIG. 1. A sheet 1 for an outer package illustrated in FIG. 1 is a sheet for an outer package that stores a power storage element in a power storage device.

The sheet 1 for an outer package of FIG. 1 has the single-layer structure of a non-porous resin sheet 2. The sheet 1 for an outer package is free of any metal layer. The term “non-porous sheet” as used herein means a sheet having a porosity determined by the following equation (1) of less than 0.9%. The porosity of the resin sheet 2 is less than 0.9%, and may be 0.8% or less, 0.7% or less, 0.6% or less, 0.5% or less, 0.4% or less, 0.3% or less, 0.2% or less, or 0.1% or less. The lower limit of the porosity is, for example, 0% or more, and may be 0.01% or more.

$$Porosity ( \% ) = ( {ρ}_{0} - {ρ}_{1} ) / {ρ}_{0} \times 100 ( \% ) \qquad ( 1 )$$

In the equation (1), po represents the density (unit: g/cm³; e.g., the true density of a resin for forming the resin sheet) of the resin sheet when it is hypothesized that the sheet is completely free of any pores, and ρ₁ represents a density W/V (g/cm³) determined from the weight W (g) of the resin sheet and the apparent volume V (cm³) thereof including pores.

In the sheet 1 for an outer package of FIG. 1, the peel force F of its main surface 3A is 1.5 N/10 mm or more. The peel force F may be determined as a peel force with respect to polypropylene (hereinafter referred to as “PP”) by the following evaluation method. The sheet 1 for an outer package only needs to have a peel force F of 1.5 N/10 mm or more on at least one surface thereof, and may have such force on each of both the surfaces thereof (the main surface 3A and a main surface 3B opposite to the main surface 3A).

### —Evaluation Method—

A rectangular test piece measuring 10 mm wide by 100 mm or more long, which is obtained by joining the sheet 1 for an outer package serving as an evaluation object and a PP sheet to each other through hot pressing, is subjected to a tear-off test in which the sheet 1 for an outer package is torn off the PP sheet at a peel rate of 300 mm/min in a 180° direction, and a 180° tear-off peel force thus measured is defined as the peel force F. The PP sheet may be a laminated sheet of the PP sheet and a sheet formed of any other material except the PP as long as a surface to which the sheet 1 for an outer package is joined includes the PP. The hot pressing is typically performed under the conditions of a temperature of from 175° C. to 185° C., a pressure of from 17 MPa to 19 MPa, and a time period of from 20 seconds to 40 seconds. A known hot pressing device may be utilized in the hot pressing. The test piece may be obtained by being cut out of the joined body of the sheet for an outer package and the PP sheet produced by the hot pressing. The length by which the sheet 1 for an outer package is torn off in the tear-off test is set to 100 mm or more. The tear-off test is performed at a temperature of 25° C.±5° C. A known tensile tester may be utilized in the tear-off test. A converted value obtained as follows may be adopted as the peel force F: a rectangular joined body whose width is not 10 mm is used as the test piece; and its 180° tear-off peel force is measured and converted into a value corresponding to a width of 10 mm.

The peel force F may be 1.7 N/10 mm or more, 2.0 N/10 mm or more, 2.3 N/10 mm or more, 2.5 N/10 mm or more, 3.0 N/10 mm or more, 3.5 N/10 mm or more, 4.0 N/10 mm or more, 4.4 N/10 mm or more, 4.5 N/10 mm or more, 5.0 N/10 mm or more, or 5.5 N/10 mm or more. The upper limit of the peel force F is, for example, 50 N/10 mm or less.

The resin sheet 2 contains one or two or more kinds of resins A. The resin A is typically a resin different from the PP. In other words, the resin sheet 2 is typically different from the PP sheet. However, the resin sheet 2 may contain the PP, and for example, may contain a mixed resin of the PP and any other resin. The resin A may be a resin having permeability for at least one kind of gas, which is selected from the group consisting of: carbon dioxide (CO₂); and methane (CH₄), higher than that of the PP. CO₂ and CH₄ are known as gases that are liable to be produced in a power storage device, in particular, a lithium-ion battery. The resin A may be a resin having permeability for at least one kind of gas, which is selected from the group consisting of: water vapor (H₂O); and oxygen (O₂), lower than that of the PP. H₂O and O₂ are known as gases that may cause the deterioration of the power storage device when permeating into the power storage device from an environment. The permeation coefficients of the PP for the above-mentioned respective gases are typically as follows: CO₂: 9.2×10⁻¹⁰ (cm³·cm)/(cm²·s·cmHg); O₂: 2.2×10⁻¹⁰ (cm³·cm)/(cm²·s·cmHg); and H₂O: 65×10⁻¹⁰ (cm³·cm)/(cm²·s·cmHg).

The resin A that may be incorporated into the resin sheet 2 is, for example, a fluororesin. The resin sheet 2 including a fluororesin sheet is particularly suitable for use in the sheet for an outer package because the sheet has chemically high stability and thermally high stability. The chemically high stability may contribute to, for example, high resistance to an electrolyte such as an electrolytic solution. In addition, the fluororesin typically has permeability for CO₂ higher than that of the polypropylene. Examples of the fluororesin include polytetrafluoroethylene (hereinafter referred to as “PTFE”), modified PTFE, an ethylene-tetrafluoroethylene copolymer (ETFE), a perfluoroalkyl vinyl ether-tetrafluoroethylene copolymer (PFA), and a hexafluoropropylene-tetrafluoroethylene copolymer (FEP). The fluororesin may be at least one kind selected from the group consisting of the resins listed above, or may be the PTFE. The resin sheet 2 containing the PTFE is particularly suitable for the suppression of the permeation of water vapor in combination with the fact that the sheet is non-porous. The fluororesin may be a meltable fluororesin that can be melt-molded like the ETFE, or may be an adhesive fluororesin having imparted thereto an adhesive property (e.g., Fluon+ADHESIVE manufactured by AGC Inc.). The modified PTFE is a copolymer of tetrafluoroethylene (TFE) and a modified comonomer. In order that a copolymer may be classified as the modified PTFE, the content of a TFE unit in the copolymer needs to be 99 mass % or more. The modified PTFE is, for example, a copolymer of TFE and at least one kind of modified comonomer selected from ethylene, a perfluoroalkyl vinyl ether, and hexafluoropropylene.

The sheet 1 for an outer package may include a non-porous PTFE sheet.

The resin sheet 2 may contain a material except the resin. Examples of the material include additives, such as a filler and a colorant. However, the main component of the resin sheet 2 is preferably the resin. The term “main component” as used herein means a component whose content is largest. The content of the resin in the resin sheet 2 is, for example, 50 mass % or more, and may be 60 mass % or more, 70 mass % or more, 80 mass % or more, 90 mass % or more, or 95 mass % or more.

The sheet 1 for an outer package of FIG. 1 has the single-layer structure of the resin sheet 2. However, the sheet 1 for an outer package is not limited to the example of FIG. 1 as long as the sheet has a peel force F of 1.5 N/10 mm or more on at least one main surface thereof. The sheet for an outer package of the present invention may include the two or more resin sheets 2 (see FIG. 2). The sheet 1 for an outer package of FIG. 2 has the laminated structure of the first resin sheet 2 (2A) and the second resin sheet 2 (2B). The first resin sheet 2A and the second resin sheet 2B may be identical to or different from each other. The sheet for an outer package of the present invention may include any other layer except the resin sheet 2. However, the sheet is preferably free of any metal layer. The main surface having the above-mentioned peel force F preferably includes the resin sheet 2.

The thickness of the sheet 1 for an outer package is, for example, from 1 μm to 200 μm, and may be from 5 μm to 150 μm, from 10 μm to 100 μm, from 15 μm to 75 μm, or from 20 μm to 50 μm.

In the sheet 1 for an outer package, the surface roughness of the surface 3A having a peel force F of 1.5 N/10 mm or more may be 30 nm or more in terms of arithmetic average roughness Ra (hereinafter referred to as “surface roughness Ra”) specified in the Japanese Industrial Standards (hereinafter referred to as “JIS”) B0601:2013, and may be 40 nm or more or 50 nm or more. The upper limit of the surface roughness Ra is, for example, 500 nm or less, and may be 400 nm or less, 300 nm or less, 250 nm or less, 200 nm or less, 180 nm or less, 160 nm or less, or 150 nm or less.

The air permeabilities of the sheet 1 for an outer package and the resin sheet 2 in their thickness directions may each be 10,000 seconds/100 mL or more in terms of air permeability (Gurley air permeability) determined in conformity with an air permeability measurement method B (Gurley-type method) specified in JIS L1096:2010.

The CO₂ permeability of the sheet 1 for an outer package is, for example, 1.0×10⁴ cm³/(m²·24 h·atm) or more in terms of CO₂ permeability measured in conformity with gas chromatography specified in JIS K7126-1:2006, and may be 3.0×10⁴ cm³/(m²·24 h·atm) or more, 5.0×10⁴ cm³/(m²·24 h·atm) or more, 7.0×10⁴ cm³/(m²·24 h·atm) or more, 9.0×10⁴ cm³/(m²·24 h·atm) or more, or 1.0×10⁵ cm³/(m²·24 h·atm) or more. The sheet 1 for an outer package having CO₂ permeability in the above-mentioned ranges is particularly suitable for use in a power storage device in which CO₂ may be produced, typically, a lithium-ion battery.

A PTFE sheet that may be included as the resin sheet 2 in the sheet 1 for an outer package is preferably a sintered sheet that has undergone the sintering of the PTFE. The term “sintering of the PTFE” as used herein means that the PTFE obtained by polymerization is heated to a temperature equal to or more than its melting point (327° C.), for example, from 340° C. to 380° C.

Examples of the shape of the sheet 1 for an outer package include: polygonal shapes including a square and a rectangle; a circular shape; an elliptical shape; and a belt shape. However, the shape of the sheet 1 for an outer package is not limited to those examples. The sheet 1 for an outer package having any one of a polygonal shape, a circular shape, and an elliptical shape can be circulated as a sheet, and the sheet 1 for an outer package having a belt shape can be circulated as a winding body (roll) wound around a core.

### [Method of Producing Sheet for Outer Package]

An example of a method of producing the sheet 1 for an outer package is described below by taking a sheet for an outer package including a PTFE sheet as an example. However, the method of producing the sheet 1 for an outer package is not limited to the following example.

### (Formation of Precursor Sheet)

First, a substrate sheet having a surface to which a PTFE dispersion is to be applied is prepared. The substrate sheet includes, for example, a resin, a metal, paper, or a composite material thereof. The surface in the substrate sheet to which the PTFE dispersion is to be applied may be subjected to peeling treatment for facilitating the peeling of a PTFE sheet from the substrate sheet. A known method may be applied to the peeling treatment. Next, a coating film of the PTFE dispersion is formed on the surface of the substrate sheet. Various known coaters may each be used in the application of the PTFE dispersion. The PTFE dispersion may be applied to the surface of the substrate sheet by immersing the substrate sheet in the PTFE dispersion. Next, the PTFE sheet is formed from the coating film of the PTFE dispersion formed on the surface of the substrate sheet by drying and sintering. Next, the formed PTFE sheet is peeled from the substrate sheet. Thus, a precursor sheet that is a cast sheet of the PTFE is obtained.

The precursor sheet that is the PTFE sheet may also be formed by the following method. First, PTFE powder (molding powder) is introduced into a mold, and a predetermined pressure is applied to the powder in the mold for a predetermined time period to perform preliminary molding. The preliminary molding may be performed at normal temperature. The shape of the internal space of the mold is preferably a columnar shape so that cutting with a cutting lathe to be described later can be performed. In this case, a columnar preliminarily molded article and a PTFE block can be obtained. Next, the resultant preliminarily molded article is removed from the mold, and is sintered at a temperature equal to or more than the melting point (327° C.) of the PTFE for a predetermined time period to provide the PTFE block. Next, the resultant PTFE block is cut into a predetermined thickness to provide the precursor sheet that is a cut sheet (skived sheet) of the PTFE. When the PTFE block has a columnar shape, a cutting lathe that continuously cuts the surface of the block while rotating the block can be utilized, and hence the PTFE sheet can be efficiently formed.

A precursor sheet except the PTFE sheet may be formed by a known approach such as a melt extrusion method.

### (Surface Processing)

Next, at least one surface of the precursor sheet is subjected to surface processing. In the surface processing, a surface shape that may exhibit a peel force F of 1.5 N/10 mm or more is given to the surface to be processed of the precursor sheet. The surface processing is, for example, press working in which a press mold having a roughened surface on its pressing surface is pressed against the surface to be processed. A sheet including a metal, a resin, a glass, or a composite material thereof may be used as the press mold. A sheet that may serve as the press mold is, for example, metal foil such as copper foil. The extent to which the pressing surface of the press mold is roughened is, for example, 0.9 μm or more and 10 μm or less in terms of maximum height Rz specified in JIS B0601:2001, and may be 1 μm or more and 5 μm or less. When the precursor sheet is a PTFE sheet, conditions for the press working are, for example, as follows: a temperature of from 360° C. to 420° C., a pressure of from 1 MPa to 10 MPa, and a time period of from 1 minute to 10 minutes. Surface-roughening treatment such as sputter etching treatment may be performed before the surface processing. When the press mold used in the press working is a thin sheet such as metal foil, the mold may be removed from the precursor sheet by an approach such as etching.

### [Use of Sheet for Outer Package]

An example of the use of the sheet 1 for an outer package is illustrated in FIG. 3. In FIG. 3, a lithium-ion battery 11 that is a kind of power storage device is illustrated. The lithium-ion battery 11 includes: an electrode group 13 and a nonaqueous electrolyte 14 that are power storage elements; and an outer package 12 that stores the power storage elements. The outer package 12 includes the sheet 1 for an outer package and a multilayer sheet 18. The multilayer sheet 18 has a multilayer structure in which a PP layer 121, an aluminum layer 122, and a polyethylene terephthalate (PET) layer 123 are laminated in the stated order. The PP layer 121 faces the inside of the lithium-ion battery 11. The outer package 12 further includes the joining portion 17 of the multilayer sheet 18 including the PP layer 121 and the sheet 1 for an outer package. The sheet 1 for an outer package is joined to a surface 16 on the inner side of the lithium-ion battery 11 in the multilayer sheet 18, in other words, the PP layer 121. More specifically, the outer package 12 of FIG. 3 has an opening 15, and the sheet 1 for an outer package is joined to the PP layer 121 so as to cover the opening 15. The sheet 1 for an outer package covers the inner surface of the opening 15, and is positioned on the inner side of the lithium-ion battery 11 with respect to the multilayer sheet 18. The opening 15 may function as, for example, a pressure release port from which a pressure is caused to escape to the outside in the case of an abnormal increase in pressure in the outer package 12 or a vent hole from which a gas generated from the power storage element (the electrode group 13 and/or the nonaqueous electrolyte 14) is discharged to the outside. The sheet 1 for an outer package can function as a sealing sheet, which can seal the opening 15 and transmit the gas generated from the power storage element to the outside.

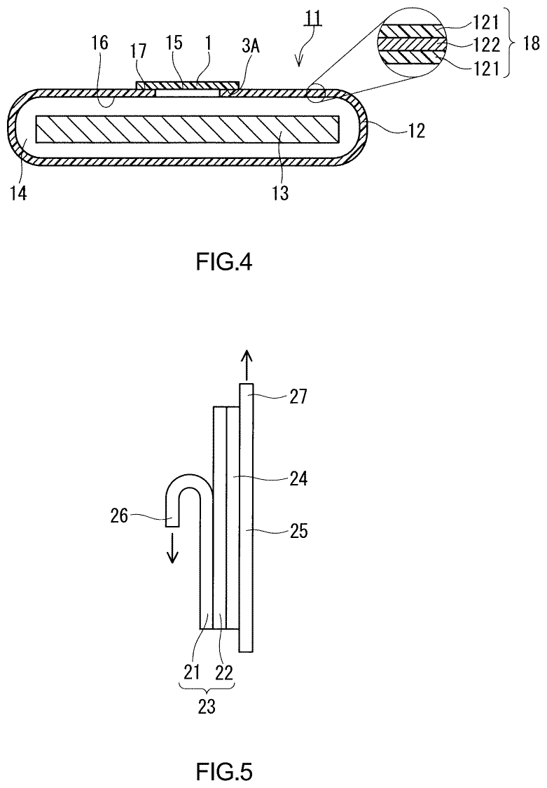

Another example of the use of the sheet 1 for an outer package is illustrated in FIG. 4. In FIG. 4, the lithium-ion battery 11 that is a kind of power storage device is illustrated. The multilayer sheet 18 included in the outer package 12 of the lithium-ion battery 11 of FIG. 4 has a multilayer structure in which the PP layer 121, the aluminum layer 122, and the PP layer 121 are laminated in the stated order. The sheet 1 for an outer package is joined to the PP layer 121 positioned on the outer side of the lithium-ion battery 11. The sheet 1 for an outer package covers the outer surface of the opening 15, and is positioned on the outer side of the lithium-ion battery 11 with respect to the multilayer sheet 18. Also in the example of FIG. 4, the sheet 1 for an outer package can function as a sealing sheet, which can seal the opening 15 and transmit the gas generated from the power storage element to the outside.

The sheet 1 for an outer package is joined to the PP layer 121 by, for example, heat welding. The heat welding may be performed by, for example, subjecting the sheet 1 for an outer package and the multilayer sheet 18 (PP layer 121) to hot pressing. Conditions for the hot pressing of the sheet 1 for an outer package including a PTFE sheet are, for example, as follows: a temperature of from 160° C. to 250° C., a pressure of from 1.0 MPa to 30.0 MPa, and a time period of from 1 second to 60 seconds. The conditions may be identical to the conditions for the hot pressing at the time of the formation of the test piece (joined body) for evaluating the peel force F.

The shape of the joining portion 17 is, for example, such a shape as to surround the opening 15 when viewed perpendicularly to the main surface of the PP layer 121. The shape of the joining portion 17 may be the shape of the peripheral edge portion of the sheet 1 for an outer package when viewed perpendicularly to the main surface of the sheet 1 for an outer package. However, the shape of the joining portion 17 is not limited to the above-mentioned examples.

In the joining portion 17, satisfactory joining of the sheet 1 for an outer package and the PP layer 121 can be achieved. A joining property may be evaluated by, for example, a water-resistant pressure, a liquid-resistant pressure, or a gas leakage pressure. The water-resistant pressure and the liquid-resistant pressure may each be evaluated as, for example, a pressure determined as follows: under a state in which a liquid, such as water or the nonaqueous electrolyte 14, is stored in the outer package 12 including the joining portion 17, a pressure is applied to the liquid; and the pressure at which the liquid starts to leak from the joining portion 17 is determined. The gas leakage pressure may be evaluated as, for example, a pressure determined as follows: under a state in which an evaluation gas is stored in the outer package 12 including the joining portion 17, a pressure is applied to the gas; and the pressure at which the gas starts to leak from the joining portion 17 is determined. The gas is, for example, air.

In general, the nonaqueous electrolyte 14 of the lithium-ion battery 11 is liable to dissolve an organic material. Accordingly, it is difficult to join the sheet 1 for an outer package to the multilayer sheet 18 with a pressure-sensitive adhesive or an adhesive. Accordingly, when a power storage device is the lithium-ion battery 11, the use of the sheet 1 for an outer package is particularly advantageous. From the above-mentioned viewpoint, the sheet 1 for an outer package may be a sheet for a lithium-ion battery.

The lithium-ion battery 11 of FIG. 3 is a pouch type. The sheet 1 for an outer package that can secure a peel force F of 1.5 N/10 mm or more without being combined with any fixing member is particularly suitable for use in a pouch-type lithium-ion battery whose internal space is limited. From the above-mentioned viewpoint, the sheet 1 for an outer package may be a sheet for a pouch-type power storage device.

The outer package 12 may include a PP sheet instead of the multilayer sheet 18 or in addition to the multilayer sheet 18. At this time, the outer package 12 may further include the joining portion 17 of the PP sheet and the sheet 1 for an outer package.

The electrode group 13 typically includes a positive electrode, a negative electrode, and a separator that separates the positive electrode and the negative electrode from each other. The nonaqueous electrolyte 14 may be a solution or a solid electrolyte such as gel. The lithium-ion battery 11 may have a known configuration except that the battery includes the sheet 1 for an outer package.

The usage mode of the sheet 1 for an outer package is not limited to the above-mentioned examples. For example, the sheet 1 for an outer package may be positioned on the inner side of the lithium-ion battery 11 with respect to the multilayer sheet 18 or the PP sheet, or may be positioned on the outer side thereof. In addition, the sheet 1 for an outer package may be used in a mode except such a mode as to cover an opening arranged in the multilayer sheet 18 or the PP sheet. The sheet 1 for an outer package may be used in combination with a sheet except the multilayer sheet 18 and the PP sheet. The sheet may be used in any mode as long as requirements for an outer package are satisfied.

The power storage device that can use the sheet 1 for an outer package is not limited to the above-mentioned example. The power storage device may be a lithium-ion battery except a pouch-type lithium-ion battery such as a rectangular or cylindrical lithium-ion battery. In addition, the power storage device may be a battery except a lithium-ion battery or an electric double layer capacitor. The power storage device may be an on-vehicle device. There has been a strong demand for the downsizing of the on-vehicle device because an arrangement space in a vehicle is limited. The sheet 1 for an outer package that can secure a peel force F of 1.5 N/10 mm or more without being combined with any fixing member is particularly suitable for use in the on-vehicle device.

### [Power Storage Device]

An example of the power storage device of the present invention is illustrated in FIG. 3. The power storage device (lithium-ion battery 11) of FIG. 3 includes: the electrode group 13 and the nonaqueous electrolyte 14 that are power storage elements; and the outer package 12 that stores the power storage elements. The outer package 12 includes the sheet 1 for an outer package. An aspect that may be adopted by the power storage device of the present invention is the same as an aspect that may be adopted by the power storage device illustrated in FIG. 3.

The power storage device of FIG. 3 is a lithium-ion battery cell. The power storage device of the present invention may be a lithium-ion battery module including an aggregate of the cells, or a lithium-ion battery pack including an aggregate of the modules.

### EXAMPLES

The present invention is described in more detail below by way of Examples. The present invention is not limited to Examples below.

First, a method of evaluating a sheet for an outer package produced in this Example is described.

### [Porosity]

The porosity of the sheet for an outer package was calculated by the following equation (1).

$$Porosity ( \% ) = ( {ρ}_{0} - {ρ}_{1} ) / {ρ}_{0} \times 100 ( \% ) \qquad ( 1 )$$

The true density (2.2 g/cm³) of PTFE was used as po in the equation (1). ρ₁ was calculated by the equation “ρ₁=W/V” from the weight W (g) of the sheet for an outer package and the apparent volume V (cm³) thereof including pores.

### [Peel Force F]

The peel force F of the sheet for an outer package was evaluated by the above-mentioned method. However, a biaxially stretched polypropylene sheet (OPP; manufactured by Toray Industries, Inc., TORAYFAN 2500H, thickness: 60 μm) was used as a PP sheet. A test piece was produced by: forming a joined body of the sheet for an outer package and the PP sheet through hot pressing at a temperature of 180° C. and a pressure of 18 MPa for a time period of 30 seconds; and cutting the joined body into a size measuring 10 mm wide by 100 mm long. The hot pressing was double-sided heating in which heat was applied to the sheet for an outer package and the PP sheet from both surfaces. In each of the sheets for outer packages except that of Comparative Example 1, the joining was performed so that a surface-processed surface and the PP sheet were brought into contact with each other. In the sheet for an outer package of Comparative Example 1, the joining was performed so that one main surface and the PP sheet were brought into contact with each other. The test piece was subjected to a 180° tear-off test as described below (see FIG. 5).

A double-sided pressure-sensitive adhesive tape 24 having the same width and length as those of a test piece 23 was prepared, and was bonded to the test piece 23 while two sides in their lengthwise directions were aligned with each other. No. 5000 NS manufactured by Nitto Denko Corporation was used as the double-sided pressure-sensitive adhesive tape 24. Next, the test piece 23 was bonded to the following stainless steel (SUS403)-made fixing plate 25 with the double-sided pressure-sensitive adhesive tape 24: the plate had a length and a width larger than those of the test piece 23 and the double-sided pressure-sensitive adhesive tape 24; and the plate had a thickness enough to be free from deforming during the test. The bonding was performed so that the entirety of the exposed surface of the double-sided pressure-sensitive adhesive tape 24 was joined to the fixing plate 25. The No. 5000 NS had pressure-sensitive adhesive strength enough to prevent the fixing plate 25 and the test piece 23 from peeling from each other during the test. Next, an end portion 27 of the fixing plate 25 was fixed to the upper chuck of a tensile testing device. In addition, an upper end portion 26 of a sheet 21 for an outer package was peeled from a PP film 22, folded back by 180°, and fixed to the lower chuck of the tensile testing device. Under the state, the peel force F was evaluated by performing a 180° tear-off test (peel rate: 300 mm/min) in which the sheet 21 for an outer package was torn off the PP film 22 in a 180° direction. AG-1 manufactured by Shimadzu Corporation was used as the tensile tester. The tear-off test was performed in an atmosphere at 23° C.

### [Surface Roughness Ra]

The surface roughness Ra of the surface of the sheet for an outer package where the peel force F was evaluated was evaluated with an atomic force microscope (manufactured by Hitachi High-Tech Science Corporation, AFM5300) capable of performing measurement in conformity with the specifications of JIS B0601:2013. A measurement mode was set to a dynamic force (DFM) mode, and a silicon-made probe (AC160TS manufactured by Olympus Corporation, product corresponding to a spring constant of 40 N/m) was used as a cantilever. A measurement range was set to a 30-micrometer square, and a measurement atmosphere was the air.

### [Carbon Dioxide Permeability]

The carbon dioxide permeability of the sheet for an outer package was evaluated with GTR-30XACK manufactured by GTR Tec Corporation capable of performing measurement in conformity with gas chromatography specified in JIS K7126-1:2006. However, carbon dioxide was used as a test gas, the shape of a test piece was set to a circular shape having a diameter of 70 mm, and a gas permeation region was set to a circular shape having a diameter of 44 mm (permeation area: 15.2 cm²). The measurement was performed under the condition of a humidity of 0% RH.

### Example 1

One part by mass of a fluorine-based surfactant (manufactured by DIC Corporation, MEGAFACE F-1 42D) with respect to 100 parts by mass of PTFE was added to a PTFE dispersion (concentration of PTFE powder: 40 mass %, average particle diameter of the PTFE powder: 0.2 μm, containing 6 parts by mass of a nonionic surfactant with respect to 100 parts by mass of the PTFE). Next, a coating film of the PTFE dispersion was formed on an elongated polyimide film (thickness: 125 μm) by immersing the polyimide film in the PTFE dispersion and lifting the film. The thickness of the coating film was determined to be 20 μm with a measuring bar. Next, the entirety was heated at 100° C. for 1 minute and then at 390° C. for 1 minute so that water in the coating film was removed, and the particles of the PTFE powder were bonded to each other to form a film shape. After the immersion and the heating described above had been further repeated six times, the resultant was peeled from the polyimide film to provide a PTFE cast film (thickness: 55 μm) serving as a precursor sheet. Next, one surface of the resultant cast film was subjected to sputter etching treatment. Conditions for the sputter etching treatment were set as follows: a treatment pressure of 3.0 Pa, an Ar atmosphere, and an energy amount of 0.7 J/cm². Next, copper foil (manufactured by Mitsui Kinzoku, 3EC-Ill, maximum height Rz of a pressing surface=5 μm) was arranged on the sputter etching-treated surface, and the resultant was subjected to surface processing by press working under the conditions of a temperature of 380° C., a pressure of 6 MPa, and a time period of 5 minutes. Next, the copper foil was removed by etching treatment with a treatment liquid formed of an aqueous solution of ferric chloride. Thus, a sheet for an outer package of Example 1 having, as a surface-processed surface, the surface from which the copper foil had been removed was obtained.

### Example 2

A sheet for an outer package of Example 2 one surface of which was subjected to surface processing was obtained in the same manner as in Example 1 except that the copper foil used in the surface processing was changed to CF-V9S-SV manufactured by Fukuda Metal Foil & Powder Co., Ltd. (maximum height Rz of a pressing surface=1.5 μm).

### Example 3

A sheet for an outer package of Example 3 one surface of which was subjected to surface processing was obtained in the same manner as in Example 1 except that the copper foil used in the surface processing was changed to CF-T4X-SV manufactured by Fukuda Metal Foil & Powder Co., Ltd. (maximum height Rz of a pressing surface=1.0 μm).

### Comparative Example 1

The PTFE cast film (thickness: 55 μm) produced in Example 1 was used as a sheet for an outer package of Comparative Example 1 without being subjected to sputter etching treatment and surface processing.

### Comparative Example 2

A sheet for an outer package of Comparative Example 2 one surface of which was subjected to surface processing was obtained in the same manner as in Example 1 except that the copper foil used in the surface processing was changed to CF-T9DA-SV manufactured by Fukuda Metal Foil & Powder Co., Ltd. (maximum height Rz of a pressing surface=0.85 μm).

The results of the evaluations of the respective sheets for outer packages of Examples and Comparative Examples are shown in Table 1 below.

TABLE 1

| | | | | Compar- | Compar- |
|---|---|---|---|---|---|
| | | | | ative | ative |
| | Example 1 | Example 2 | Example 3 | Example 1 | Example 2 |
| Porosity (%) | 0.0 | 0.0 | 0.0 | 0.0 | 0.0 |
| Peel force F | 1.7 | 4.4 | 6.5 | 0.1 | 0.03 |
| (N/10 mm) | | | | | |
| Surface | 154 | 231 | 51 | 27 | 7 |
| roughness | | | | | |
| Ra (nm) | | | | | |

The carbon dioxide permeability of the PTFE cast film used in each of Examples and Comparative Examples was 1.01×10⁵ (cm³/(m²·24 h·atm)) in a state before the performance of the sputter etching treatment and the surface processing.

### INDUSTRIAL APPLICABILITY

The sheet for an outer package of the present invention can be used as a sheet for an outer package that stores a power storage element in a power storage device.

1. A sheet for an outer package configured to store a power storage element in a power storage device,
the sheet for an outer package comprising a non-porous resin sheet,
wherein the sheet for an outer package has a peel force F of 1.5 N/10 mm or more, which is determined by the following evaluation method:
—Evaluation Method—
a rectangular test piece measuring 10 mm wide by 100 mm or more long, which is obtained by joining the sheet for an outer package serving as an evaluation object and a polypropylene sheet to each other through hot pressing, is subjected to a tear-off test in which the sheet for an outer package is torn off the polypropylene sheet at a peel rate of 300 mm/min in a 1800 direction, and a 1800 tear-off peel force thus measured is defined as the peel force F.

2. The sheet for an outer package according to claim 1, wherein the resin sheet contains a fluororesin.

3. The sheet for an outer package according to claim 2, wherein the fluororesin is polytetrafluoroethylene.

4. The sheet for an outer package according to claim 1, wherein the sheet for an outer package has a main surface having a surface roughness of 30 nm or more in terms of arithmetic average roughness Ra specified in JIS B0601:2013.

5. The sheet for an outer package according to claim 1, wherein the power storage device is a lithium-ion battery.

6. The sheet for an outer package according to claim 5, wherein the lithium-ion battery is a pouch type.

7. A power storage device, comprising:
a power storage element; and
an outer package configured to store the power storage element,
wherein the outer package includes the sheet for an outer package of claim 1.

8. The power storage device according to claim 7, wherein the outer package further includes:
a multilayer sheet including a polypropylene layer or a polypropylene sheet; and
a joining portion of the sheet for an outer package and the polypropylene layer or the polypropylene sheet.
